(19) United States
(12) Patent Application Publication
(10) Pub. No.: US 2026/0304023 A1
(43) Pub. Date: Oct. 1, 2026

(54) WEARABLE DEVICE

(71) Applicant: Merry Electronics(Shenzhen) Co., Ltd., ShenZhen (CN)

(72) Inventors: Hung-Wei Chen, Taichung (TW); Chun-Hung Chang, Taichung (TW); Chih-Hung Liu, Taichung (TW); Po Hsun Sung, Taichung (TW)

(73) Assignee: Merry Electronics(Shenzhen) Co., Ltd., ShenZhen (CN)

(21) Appl. No.: 19/196,668

(22) Filed: May 1, 2025

(30) Foreign Application Priority Data
Apr. 1, 2025 (TW) 114112508

(51) Int. Cl. H04R 1/10

(52) U.S. Cl. CPC H04R 1/1083

(57) ABSTRACT

A wearable device including an acoustical component and a wearing component is provided. The acoustical component includes a guide surface located on a virtual plane. The wearing component is connected to the acoustical component, and an extension line of the acoustical component is different from an extension line of the wearing component. When the wearable device is worn on an ear, at least one of the acoustical component and the wearing component contacts at least one of a tragus and a concha cavity of the ear, and an airflow flows forms a stagnation point on the guide surface and a first region on the second side. The Reynolds number of the airflow in the first region is less than 4000, and an atmosphere sound inlet of an atmosphere sound channel formed by the wearable device is located at the second side and located in the first region.

### CROSS-REFERENCE TO RELATED APPLICATION

This application claims the priority benefit of Taiwan application serial no. 114112508, filed on Apr. 1, 2025. The entirety of the above-mentioned patent application is hereby incorporated by reference herein and made a part of this specification.

### BACKGROUND

### Technical Field

The disclosure relates to a wearable device.

### Description of Related Art

The modern wearable device includes an open-type earphone. The feature of the open-type earphone is that the earphone does not completely cover or block the inlet of the ear canal, keeping a larger distance between the sound outlet of the earphone and the ear canal. There is a larger gap between open-type headphone and the inlet of the ear canal, allowing user to hear external sounds (i.e., the atmosphere sound) through the gap. However, when a user wears open-type headphone, an airflow from the environment easily generates a turbulence around the earphone and the ear, producing a greater wind noise, which leads to increased noise in the atmosphere sound transmitted into the ear, thereby reducing the audio performance of the open-type earphone.

### SUMMARY

The disclosure provides a wearable device with improved audio performance.

The wearable device of the disclosure is adapted to be worn on an ear. The wearable device includes an acoustical component and a wearing component. The acoustical component includes a guide surface, the guide surface is located in a virtual plane. The wearing component is connected to the acoustical component, an extension axis of the acoustical component is different from an extension axis of the wearing component. When the wearable device is worn on the ear, at least one of the acoustical component and the wearing component contacts at least one of a tragus and a cavum conchae of the ear, an airflow flows from a first side of the virtual plane toward a second side of the virtual plane. The airflow forms a stagnation point on the guide surface and forms a first region at the second side. A Reynolds number of the airflow in the first region is less than 4000, an atmosphere sound inlet of an atmosphere sound channel formed by the wearable device is located at the second side and in the first region.

Based on the above, when the wearable device of the disclosure is worn on the ear, the guide surface of the acoustical component guides the airflow from the environment, forming a first region at the second side of the virtual plane. The atmosphere sound inlet of the atmosphere sound channel formed by the wearable device is located within the first region, used to guide the atmosphere sound into the ear. Since the Reynolds number of the airflow in the first region is smaller, a wind noise generated by the airflow is reduced, thereby reducing the noise of the atmosphere sound transmitted into the ear from the atmosphere sound inlet, so as to improving an audio performance of the wearable device.

### BRIEF DESCRIPTION OF THE DRAWINGS

FIG. 1A is a schematic diagram of a wearable device according to an embodiment of the disclosure when worn on an ear.

FIG. 1B is a schematic diagram of a user in FIG. 1A.

FIG. 2 is a sectional view of the wearable device in FIG. 1A when worn on the ear.

FIG. 3 is a schematic diagram of the wearable device in FIG. 1A.

FIG. 4 is a schematic diagram of the wearable device in FIG. 3 from another viewing angle.

FIG. 5 is a sectional view of the wearable device in FIG. 3.

FIG. 6 is a schematic diagram of a wearable device according to another embodiment of the disclosure.

FIG. 7 is a schematic diagram of the wearable device in FIG. 6 from another viewing angle.

FIG. 8 is a sectional view of the wearable device in FIG. 6 when worn on the ear.

### DESCRIPTION OF THE EMBODIMENTS

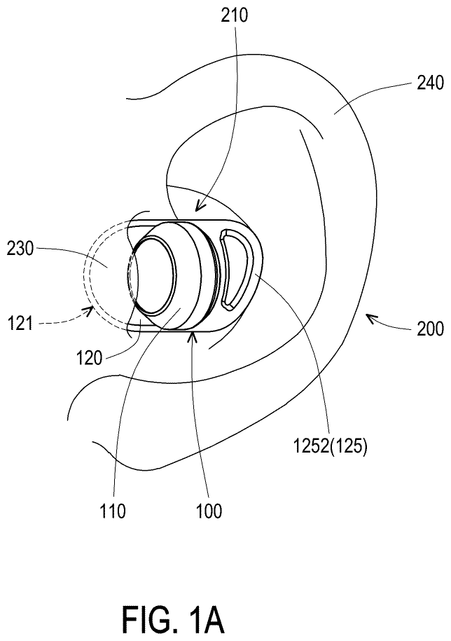

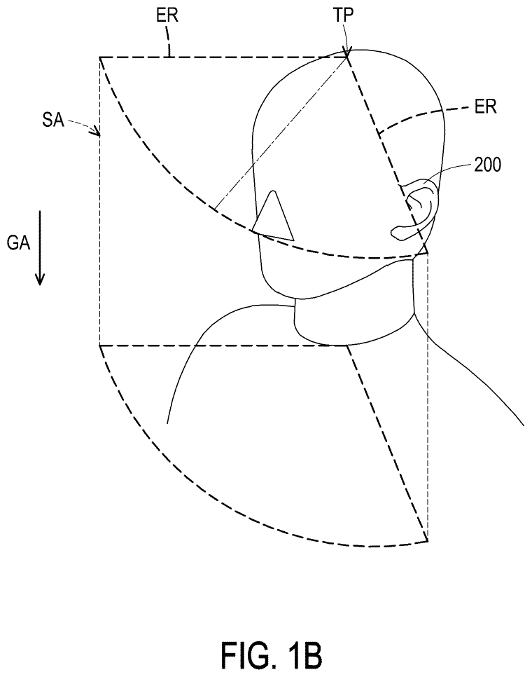

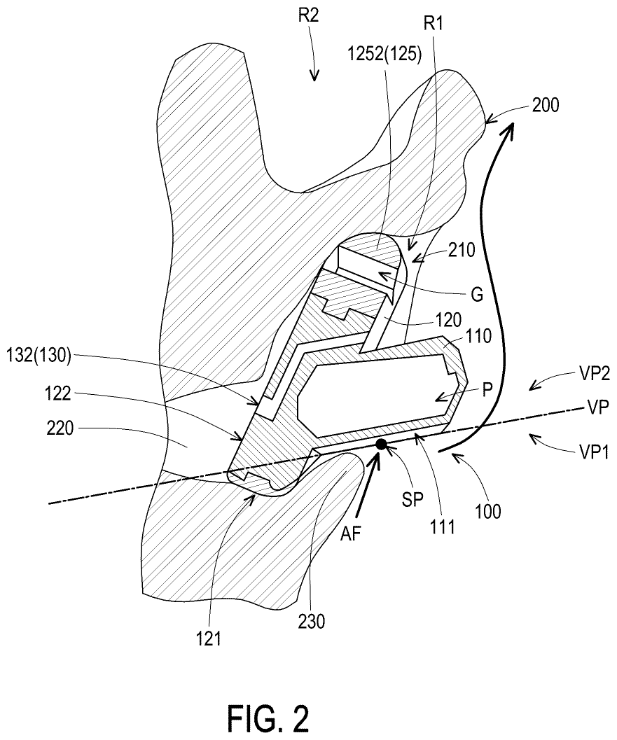

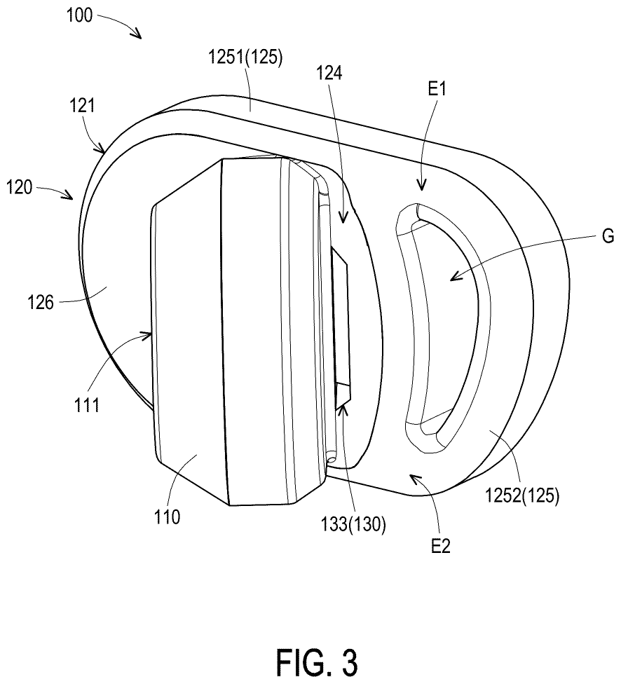

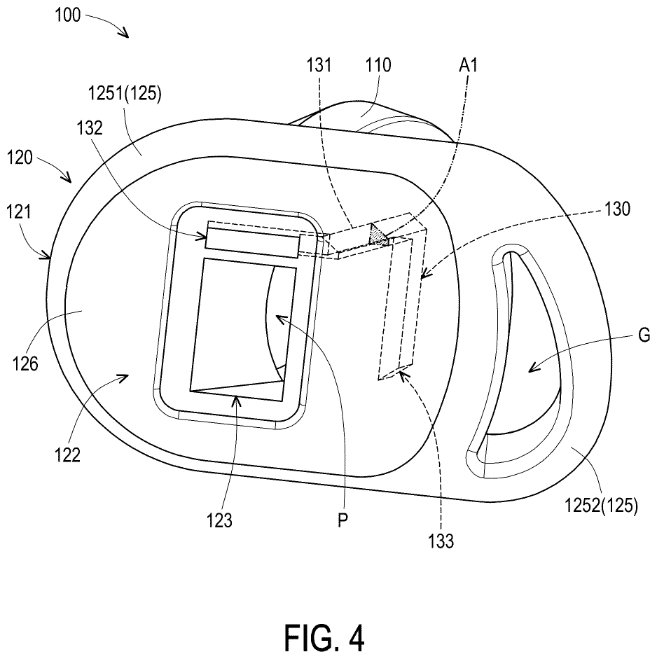

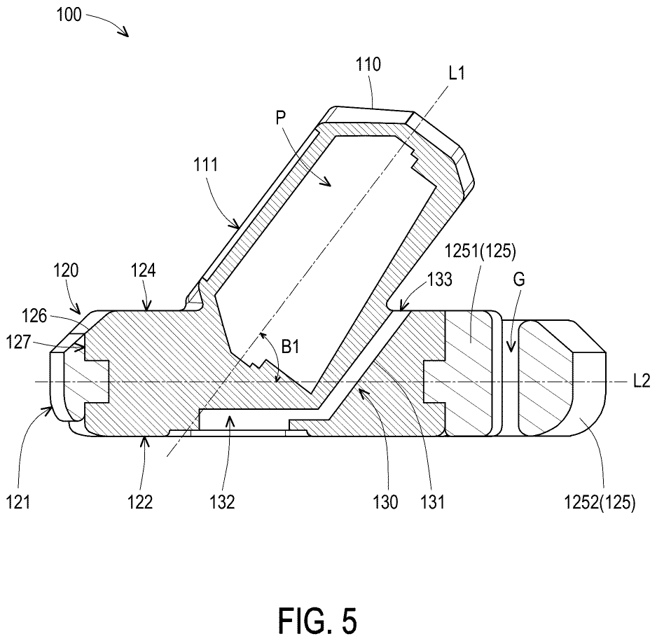

FIG. 1A is a schematic diagram of a wearable device according to an embodiment of the disclosure when worn on an ear. FIG. 1B is a schematic diagram of a user in FIG. 1A. FIG. 2 is a sectional view of the wearable device in FIG. 1A when worn on the ear. FIG. 3 is a schematic diagram of the wearable device in FIG. 1A. FIG. 4 is a schematic diagram of the wearable device in FIG. 3 from another viewing angle. FIG. 5 is a sectional view of the wearable device in FIG. 3. Refer to FIG. 1A to FIG. 5 at the same time, the wearable device 100 may be worn on an ear 200. The wearable device 100 includes an acoustical component 110 and a wearing component 120. The wearing component 120 is connected to the acoustical component 110. The acoustical component 110 and the wearing component 120 together form an acoustic chamber P. A plurality of acoustic elements and a plurality of electronic elements (not shown) may be disposed in the acoustic chamber P. The acoustical component 110 includes a guide surface 111, the guide surface 111 is located in a virtual plane VP. An extension axis L1 of the acoustical component 110 is different from an extension axis L2 of the wearing component 120, causing the acoustical component 110 to be inclinedly connected to the wearing component 120. The virtual plane VP is parallel to the extension axis L1 of the acoustical component 110. The wearable device 100 of this embodiment is, for example, an open-type earphone, but not limited thereto.

When the wearable device 100 is worn on the ear 200, at least one of the acoustical component 110 and the wearing component 120 contacts at least one of a tragus 230 and a cavum conchae 210 of the ear 200, thereby making the wearable device 100 stably worn on the ear 200, and blocking an airflow AF from directly entering an ear canal 220 of the ear 200. The airflow AF flows from a first side VP1 of the virtual plane VP toward a second side VP2 of the virtual plane VP. The guide surface 111 is used to guide the airflow AF, allowing the airflow AF to flow along the arrow shown in FIG. 2. The airflow AF forms a stagnation point SP on the guide surface 111 (the virtual plane VP), and is guided by the guide surface 111 to form a first region R1 and a second region R2 at the second side VP2. The first region R1 is located between the stagnation point SP and the second region R2, a Reynolds number of the airflow AF in the first region R1 is less than 4000, a Reynolds number of the airflow AF in the second region R2 is greater than 4000. The airflow AF generates greater wind noise around the stagnation point SP and in the second region R2.

An atmosphere sound inlet 133 of an atmosphere sound channel 130 formed by the wearable device 100 is located at the second side VP2 and in the first region R1. The atmosphere sound channel 130 is used to input the external sound (i.e., atmosphere sound) into the ear 200. Thereby, the wearable device 100 may still transmit atmosphere sound to an ear canal 220 through the atmosphere sound channel 130 even when covering most of the cavum conchae 210, to make the ratio of the audio generated by the wearable device 100 and the atmosphere sound more stable. The atmosphere sound channel 130 of this embodiment is away from the stagnation point SP and formed in the first region R1 where the airflow is more stable, which may avoid the wind noise generated by the airflow from entering the ear canal 220 of the ear 200 through the atmosphere sound channel 130, thereby enhancing the audio experience.

Here, the airflow AF is defined as the airflow blowing from the front of the user toward the ear 200. As shown in FIG. 1B, using a top TP of the user's head as a reference point, a connection line between the top TP and an extension axis of the nose tip as a reference line, two boundary lines ER intersecting at the top TP at an angle of 60 degrees with the reference line on a plane enclose a sector surface. This sector surface extends along a gravity direction GA to the neck to form a sector region SA, which is the front region of the user referred to in this embodiment.

According to the Reynolds number equation in fluid dynamics, wherein V is the velocity of the airflow, L is the fluid characteristic length, and υ is the kinematic viscosity of the airflow. The Reynolds number Re less than 2100 indicates that the airflow in the region is a laminar flow, the Reynolds number Re greater than 4000 indicates that the airflow in the region is a turbulent flow, and the Reynolds number Re between these two values indicates that the airflow in the region is a transitional flow. The airflow AF in the first region R1 of this embodiment includes the laminar flow and the transitional flow, while the airflow AF in the second region R2 includes the turbulent flow. The laminar flow and the transitional flow are more stable and less likely to generate the wind noise.

$$Re = VL / υ$$

The fluid characteristic length of the wearable device 100 of this embodiment is between 5 and 15 millimeters, preferably is 10 millimeters. In a general environment, the flow velocity of the airflow AF is between 0.3 and 6 m/s, and the kinematic viscosity of the airflow AF is approximately 0.0000146 m2/s. When the wearable device 100 of this embodiment is worn on the ear 200 and the flow velocity of the airflow AF is 5.5 m/s, the Reynolds number Re of the airflow AF located in the first region R1 is approximately 3770. The wearable device 100 reduces the Reynolds number Re of the airflow by using a smaller fluid characteristic length to ensure that the airflow AF may form the first region R1 at the second side VP2 of the virtual plane VP.

As shown in FIG. 2 to FIG. 4, the wearing component 120 of this embodiment includes a positioning portion 121, a sound output surface 122, a sound input surface 124, and an acoustic sound outlet 123. The sound input surface 124 is opposite to the sound output surface 122. When the wearable device 100 is worn on the ear 200, the sound input surface 124 faces the environment and serves as the top surface of the wearing component 120, and the sound output surface 122 faces the ear canal 220 and serves as the bottom surface of the wearing component 120. The acoustical component 110 is connected to the sound input surface 124, but not limited thereto. The acoustic sound outlet 123 is located on the sound output surface 122 and communicates with the acoustic chamber P. The audio generated by the wearable device 100 is transmitted outward (e.g., to the ear canal 220) from the acoustic sound outlet 123. A portion of the wearing component 120 (e.g., the positioning portion 121) may be located at the first side VP1 of the virtual plane VP, but not limited thereto.

As shown in FIG. 5, the wearing component 120 of this embodiment specifically includes a support structure 125 and a wearing body 126 connected to each other. The material of the support structure 125 may be elastic material, but not limited thereto. The wearing body 126 includes a sound output surface 122, a sound input surface 124, and a connecting surface 127, and the acoustical component 110 is connected to the wearing body 126. The connecting surface 127 is connected between the sound output surface 122 and the sound input surface 124, and the connecting surface 127 is the side surface of the wearing body 126. The wearing body 126 and the support structure 125 are connected through the engagement of grooves and protrusions, but not limited thereto.

The support structure 125 includes a first portion 1251 and a second portion 1252. The first portion 1251 is connected to the wearing body 126. The positioning portion 121 is located at the first portion 1251 of the support structure 125. The shape of the positioning portion 121 is an arc shape, but not limited thereto. The second portion 1252 includes two opposite ends E1, E2. The two ends E1, E2 are connected to the first portion 1251. There is a hollow structure G between the second portion 1252 and the first portion 1251. The first portion 1251 and the second portion 1252 are, for example, integrally formed, but not limited thereto.

As shown in FIG. 3 to FIG. 5, the atmosphere sound channel 130 of the wearable device 100 of this embodiment is located at the wearing body 126 of the wearing component 120, but not limited thereto. In an embodiment not shown, the atmosphere sound channel 130 may be located between the wearing body 126 and the support structure 125, and may be a gap formed between the wearing body 126 and the support structure 125. The atmosphere sound channel 130 further includes a channel body 131 and an atmosphere sound outlet 132. The atmosphere sound outlet 132 and at least a portion of the atmosphere sound inlet 133 are communicated with the channel body 131. The atmosphere sound outlet 132 is located on the sound output surface 122, and the atmosphere sound inlet 133 is located on the sound input surface 124. The atmosphere sound enters the channel body 131 from the atmosphere sound inlet 133 and exits from the atmosphere sound outlet 132. Since the extension axis L1 of the acoustical component 110 is different from the extension axis L2 of the wearing component 120, the projection of the acoustical component 110 to the wearing component 120 covers the atmosphere sound inlet 133. The channel body 131 of this embodiment is disposed in the wearing component 120 at an incline along a direction parallel to the extension axis L1, but not limited thereto.

The shape of a cross section A1 of the channel body 131, the shape of the atmosphere sound inlet 133, and the shape of the atmosphere sound outlet 132 of this embodiment are different from each other, but not limited thereto. In an embodiment not shown, the shapes of the cross section A1, the atmosphere sound inlet 133, and the atmosphere sound outlet 132 may be any polygon or circular shape. The shapes of the cross section A1, the atmosphere sound inlet 133, and the atmosphere sound outlet 132 may be the same. The area of the acoustic sound outlet 123 is greater than or equal to the area of the atmosphere sound outlet 132. The cross-sectional area (the area of cross section A1) of the channel body 131 is less than or equal to the area of the atmosphere sound inlet 133, and less than or equal to the area of the atmosphere sound outlet 132, but not limited thereto. In this embodiment, the area of the acoustic sound outlet 123 is greater than the area of the atmosphere sound outlet 132, the cross-sectional area of the channel body 131 is less than the area of the atmosphere sound inlet 133 and less than the area of the atmosphere sound outlet 132, and only a portion of the atmosphere sound inlet 133 is communicated with the channel body 131.

As shown in FIG. 2, when the wearable device 100 is worn on the ear 200, the positioning portion 121 of the wearing component 120 extends into the ear 200 and abuts the cavum conchae 210 of the ear 200, and the tragus 230 of the ear 200 covers the positioning portion 121. The second portion 1252 of the support structure 125 of the wearing component 120 abuts the cavum conchae 210, and the wearable device 100 is stably connected to the ear 200 through the positioning portion 121 and the second portion 1252. Since the hollow structure G between the second portion 1252 and the first portion 1251, the second portion 1252 may be deformed by pressure from the cavum conchae 210, and the second portion 1252 is adapted to the ears 200 with different shapes. The guide surface 111 of the acoustical component 110 contacts the tragus 230, but not limited thereto. The wearable device 100 covers the ear 200 over a large area, thereby making the gap between the wearable device 100 and the ear 200 smaller than the area of the cross section A1 of the channel body 131 of the atmosphere sound channel 130 (i.e., the cross-sectional area of the channel body 131), to ensure that most of the atmosphere sound is transmitted to the ear canal 220 through the atmosphere sound channel 130.

Thereby, the wearable device 100 may be stably connected to the ears 200 with different shapes, to enhance the usability of the wearable device 100. The sound output surface 122 of the wearing component 120 faces the ear canal 220 of the ear 200, to shorten the distance between the acoustic sound outlet 123 and the atmosphere sound outlet 132 on the sound output surface 122 and the ear canal 220, thereby reducing the energy attenuation degree of the audio and atmosphere sound of the wearable device 100 input to the ear canal 220, enhancing the audio experience and audio performance of the wearable device 100.

The structures of the positioning portion 121 and the second portion 1252 of the wearing component 120 are not limited to this embodiment. In an embodiment not shown, the structure of the positioning portion 121 may be the same as the second portion 1252, meaning that the hollow structure G may be located between the positioning portion 121 and the first portion 1251. In an embodiment not shown, the shape of the second portion 1252 may be arc-shaped, the second portion 1252 may have the same structure as the positioning portion 121. The disposed way and position of the atmosphere sound channel 130 are not limited to this embodiment. In an embodiment not shown, the channel body 131 may be disposed on the wearing component 120 along a direction perpendicular to the extension axis L2. That is, the channel body 131 may extend vertically. In an embodiment not shown, the atmosphere sound channel may be a path of specific dimensions formed between the wearable device 100 and the ear 200 when the wearable device 100 is worn on the ear 200, or a passage formed on the wearable device 100 in other ways.

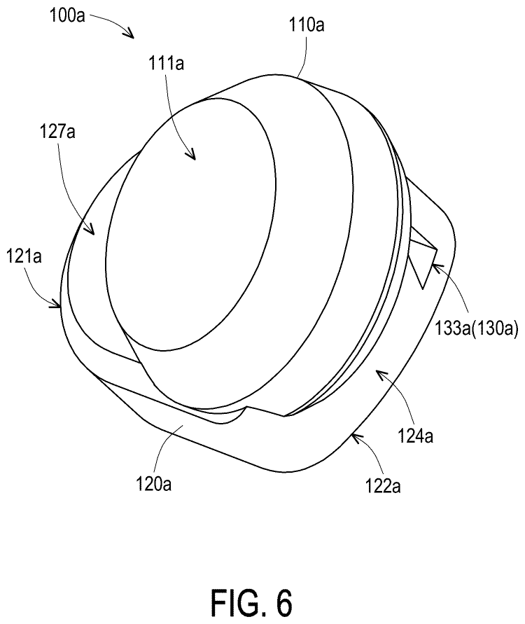

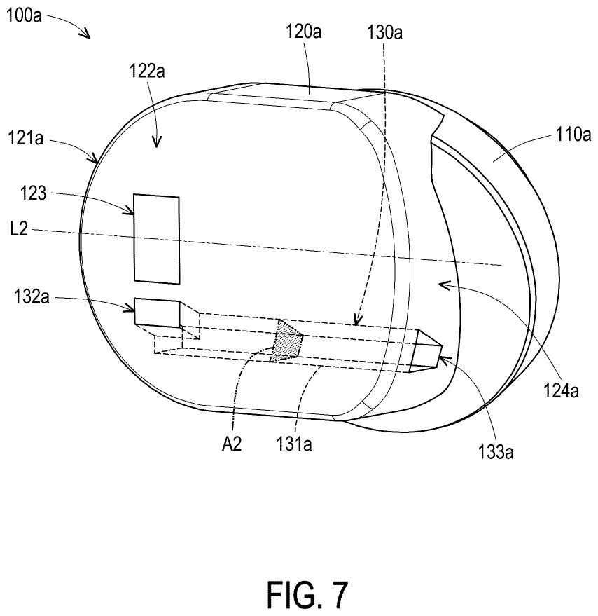

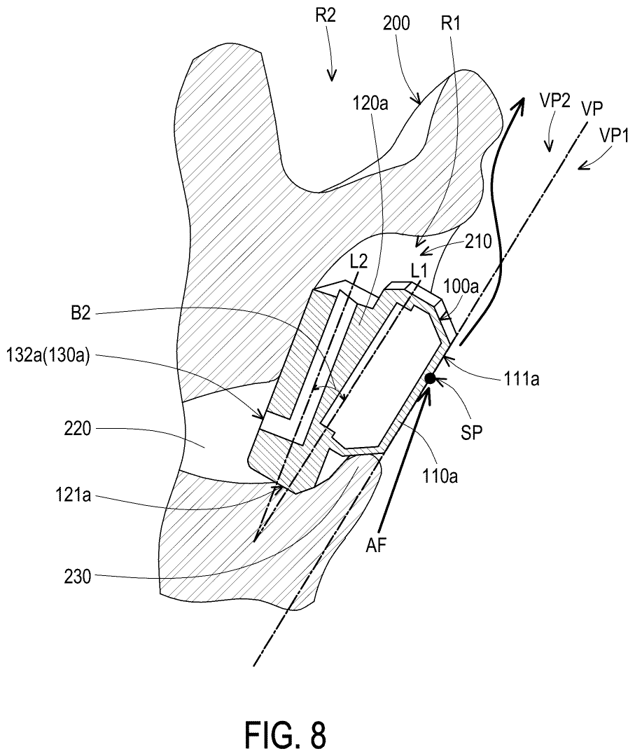

FIG. 6 is a schematic diagram of a wearable device according to another embodiment of the disclosure. FIG. 7 is a schematic diagram of the wearable device in FIG. 6 from another viewing angle. FIG. 8 is a sectional view of the wearable device in FIG. 6 when worn on the ear. Please refer to FIG. 4, FIG. 6 to FIG. 8 at the same time, the wearable device 100a of this embodiment is similar to the previous embodiment. The difference between the two is that an angle B2 between the extension axis L1 of the acoustical component 110a and the extension axis L2 of the wearing component 120a of this embodiment is smaller than an angle B1 between the extension axis L1 of the acoustical component 110 and the extension axis L2 of the wearing component 120 of FIG. 4. The sound input surface 124a of the wearing component 120a is connected between the sound output surface 122a and the connecting surface 127a, and the connecting surface 127a is connected to the acoustical component 110a and is opposite to the sound output surface 122a. The connecting surface 127a is the top surface of the wearing component 120a, and the sound input surface 124a is the side surface of the wearing component 120a. The channel body 131a of the atmosphere sound channel 130a extends along a direction parallel to the extension axis L2 of the wearing component 120a. That is, the channel body 131a extends horizontally.

The shape of the cross section A2 of the channel body 131a is the same as the shape of the atmosphere sound inlet 133a, but not limited thereto. The area of the atmosphere sound inlet 133a is equal to the cross-sectional area of the channel body 131a (i.e., the area of the cross section A2), and is greater than the area of the atmosphere sound outlet 132a. When the wearable device 100a is connected to the ear 200, the positioning portion 121a of the wearing component 120a extends into the cavum conchae 210 and abuts the tragus 230, and the guide surface 111a of the acoustical component 110a faces the environment and away from the tragus 230. This embodiment of the wearable device 100a has the same effects as the previous embodiment, and is not repeated herein.

In summary, when the wearable device of the disclosure is worn on the ear, the guide surface of the acoustical component guides the airflow from the environment, forming a first region at the second side of the virtual plane. The atmosphere sound inlet of the atmosphere sound channel formed by the wearable device is located within the first region, used to guide the atmosphere sound into the ear. Since the Reynolds number of the airflow in the first region is smaller, a wind noise generated by the airflow is reduced, thereby reducing the noise of the atmosphere sound transmitted into the ear from the atmosphere sound inlet, so as to improving an audio performance of the wearable device.

What is claimed is:

1. A wearable device, adapted to be worn on an ear, the wearable device comprising:
an acoustical component, comprising a guide surface, the guide surface is located in a virtual plane; and
a wearing component, connected to the acoustical component, an extension axis of the acoustical component is different from an extension axis of the wearing component,
When the wearable device is worn on the ear, at least one of the acoustical component and the wearing component contacts at least one of a tragus and a cavum conchae of the ear, an airflow flows from a first side of the virtual plane toward a second side of the virtual plane, the airflow forms a stagnation point on the guide surface and forms a first region at the second side, a Reynolds number of the airflow in the first region is less than 4000, an atmosphere sound inlet of an atmosphere sound channel formed by the wearable device is located at the second side and in the first region.

2. The wearable device according to claim 1, wherein the atmosphere sound channel is located in the wearing component and comprises a channel body and an atmosphere sound outlet, the atmosphere sound outlet and at least a portion of the atmosphere sound inlet are communicated with the channel body.

3. The wearable device according to claim 2, wherein the wearing component comprises an sound input surface and a sound output surface opposite to each other, the atmosphere sound inlet is located on the sound input surface and the acoustical component is connected to the sound input surface, the atmosphere sound outlet is located on the sound output surface.

4. The wearable device according to claim 2, wherein a projection of the acoustical component to the wearing component covers the atmosphere sound inlet.

5. The wearable device according to claim 2, wherein the wearing component comprises a sound input surface and a sound output surface connected to each other, the atmosphere sound inlet is located on the sound input surface, the atmosphere sound outlet is located on the sound output surface.

6. The wearable device according to claim 5, wherein the wearing component further comprises a connecting surface, the connecting surface is opposite to the sound output surface, the sound input surface is connected between the sound output surface and the connecting surface, the connecting surface is connected to the acoustical component.

7. The wearable device according to claim 1, wherein a fluid characteristic length of the wearable device is between 5 millimeters and 15 millimeters.

8. The wearable device according to claim 1, when the wearable device is worn on the ear, the airflow forms a second region at the second side of the virtual plane, a Reynolds number of the airflow in the second region is greater than 4000, the first region is located between the second region and the stagnation point.

9. The wearable device according to claim 1, wherein the wearable device is an earphone.
